(19) United States
(12) Patent Application Publication
(10) Pub. No.: US 2013/0282541 A1
(43) Pub. Date: Oct. 24, 2013

(54) Utility Services Payment System, Methods and Apparatus

(71) Applicant: Gas South, LLC, Atlanta, GA (US)

(72) Inventors: Kevin A. Greiner, Decatur, GA (US); Vance Condary Mullis, III, Alpharetta, GA (US); Mark Steven Ridenour, Kennesaw, GA (US); Meredith W. Hodges, College Park, GA (US); J. W. Rayder, Chevy Chase, MD (US)

(21) Appl. No.: 13/923,041

(22) Filed: Jun. 20, 2013

Related U.S. Application Data
(63) Continuation of application No. 12/157,222, filed on Jun. 9, 2008.

(51) Int. Cl. G06Q 20/14; G06Q 30/04

(52) U.S. Cl. CPC G06Q 20/145; G06Q 30/04
USPC 705/34

(57) ABSTRACT

The invention provides methods, systems and apparatus for combining aspects of a prepay and post pay utility service billing arrangement. When a customer enrolls in the program with the system, utility service is initiated and a first bill is generated and transmitted; the amount of the first bill is an estimated amount of charges for the service to be provided during a first period. In subsequent billing periods, subsequent bills are generated and transmitted and each includes an estimated amount of charges for the subsequent period as well as a difference between actual and estimated charges for the service during the previous billing period, less any payments received from the customer. Service may be terminated if the customer withdraws from the program, if the customer fails to make timely payments, or for other reasons. If service is terminated, a final bill may be generated and transmitted based on actual charges, net of any amounts

### FIELD OF THE INVENTION

The present invention relates to a system, methods and apparatus useful for billing and payment systems and methods, particularly billing and payment methods and systems for use in connection with the provision of services, such as utilities like gas, electricity, water, sewer services and the like.

### BACKGROUND OF THE INVENTION

The vast majority of individuals live in houses or apartments or similar dwellings. Most such dwellings obtain electricity, gas, water, sewer and/or other services from various utilities. Such industries may be regulated, unregulated, or somewhat regulated, depending on the location of the dwelling and the applicable federal, state, and/or local laws. It is not unusual to have a given utility service available from a variety of vendors in any given location. This is generally desirable from the consumer's perspective, as the consumer has a choice of providers and such providers often compete based on pricing, services, and in other ways.

As a result of such competition among service providers and lower prices, the vendors need to carefully consider their various costs. Among other costs incurred by such vendors are the costs incurred when a customer fails to pay for the services already provided. Because utility services are usually billed and collected after the services have been provided, a vendor may not receive payment for services already provided. In such situations, a vendor may be required by applicable law to provide notice to the customer before the vendor can cease providing additional services. For example, a customer may receive a utility service such as gas for heating and cooking during January, receive a bill for such service in early February, and then not pay. If the vendor is unable to collect payment for the January service, the vendor likely will be required to continue providing service until after providing notice of termination of service to the customer and waiting a required time period before terminating further service to that customer. In such a situation, the vendor thus fails to collect for the services provided in January and also the additional services provided pending the termination of service.

Given such situations, vendors often perform credit checks on potential customers before agreeing to enroll new customers. A vendor will then determine whether or not to provide service to a customer based on that customer's credit history or credit score and the perceived risk of loss associated with customers with similar credit histories or credit scores. The terms of service offered, including deposit requirements and rate plan pricing, may also be dependent on the results of a credit check. In this way, vendors try to minimize their risk of loss due to a failure to pay.

Vendors may refuse to provide service to potential customers with bad credit histories or bad credit scores, or may refuse to offer certain rate plans or lower prices to such customers. Hence, such customers often end up paying higher prices, and may have fewer choices of vendors and/or rate plans from which to select. In some situations, a customer with a bad credit history or bad credit score may have no choice but to obtain service from a provider who is required to provide service to anyone who asks. Such a provider often charges a much higher price for services to such customers. The customer may be required to prepay for the services to be provided, such as by paying a substantial deposit prior to obtaining any services. This situation poses various problems that may unfairly penalize an individual, such as when a married couple divorces and one spouse has no credit history or an otherwise poor credit history or poor credit score, and poses substantial problems with customers who are unable to pay a large deposit.

It is conventional for some utilities to allow for payment “averaging” by customers, such that a customer pays a monthly amount that is determined to be the monthly average for the total amount expected to be charged over the year, with an annual “true up” to reflect any overpayments or underpayments if the actual charges over the year vary from the total payments by the customer. Such an approach has the disadvantages of failing to accurately assess the charges to be paid for the services provided on a monthly basis, as certain utility usage may vary dramatically from month to month and season to season, depending on the services provided and factors such as the weather.

Of course, it is conventional for vendors of various services to use various types of systems for billing and payment. In addition, some vendors have attempted to minimize the risks of non-payment by requiring a customer to prepay for services. For example, U.S. Pat. No. 6,226,364 B1, issued May 1, 2001, to O'Neil, which is hereby incorporated by reference as if fully set forth herein, involves a complex system for use in connection with prepaid telephone services. The system keeps track of in-process call details in real-time and the related billing information for prepaid telephone services. The O'Neil system keeps track of the call details and is capable of immediately disconnecting a call once a customer has used up all of the services for which the user has prepaid, or otherwise obtaining alternative payment sources. Such systems may find application in connection with telephone services, but are less applicable in connection with services that may be regulated such that a service provider is unable to immediately terminate service once the customer has used up the amount of services for which the customer has prepaid. However, it requires that the billing system monitor in real time the charges incurred.

Still another conventional system involves a prepaid calling card system for telecommunications services, as described in U.S. Pat. No. 6,463,139 B1, issued Oct. 8, 2002, to Davitt et al., which is hereby incorporated by reference as if fully set forth herein. However, this approach requires that the service be monitored in real time and allows that the service may be disconnected immediately when a prepaid balance is exceeded. Still other methods and apparatus involving prepaid calling cards for telecommunications services are addressed in U.S. Pat. No. 6,122,354, issued Sep. 19, 2000 to Dowens, which is hereby incorporated by reference as if fully set forth herein.

U.S. Pat. No. 6,122,354 discloses a method and apparatus for extending a pre-paid calling card limit. However, it requires that the provider be able to monitor in real time the charges incurred, and to shut off service immediately in case no party agrees to be billed for charges exceeding the prepaid limit: it further requires that some prepayment is made before service begins.

With respect to utility services other than telecommunications, published U.S. Patent Application No. US 2001/0051933 A1, published Dec. 13, 2001, which is hereby incorporated by reference as if fully set forth herein, discusses a system involving a prepay system for use with prepaid services for consumers for real-time consumption of gas, water and/or electricity. This published application discloses a system in which a meter is used to measure the consumption of the service and to transmit information regarding the customer's use of the service to a central database which can correlate the information from the consumers' meter and/or measurement systems to information regarding the corresponding customers' prepaid amounts and other account information. This system requires that the provider be able to monitor in real time the charges incurred and shut off service immediately in certain cases. Installation and use of such metering systems often involves substantial cost and investment by the service provider.

Still another approach is discussed in U.S. Pat. No. 6,529,883 B1, issued on Mar. 4, 2003, to Yee et al., which is hereby incorporated by reference as if fully set forth herein. The Yee patent describes the use of a prepaid “smart card” for use with energy metering. Essentially, the consumer is able to prepay for certain utility services and then uses the prepaid card to access metered services, such as electricity, gas or water.

Yet another approach is disclosed in U.S. Pat. No. 6,553,353 B1, issued on Apr. 22, 2003, to Littlejohn, which is hereby incorporated by reference as if fully set forth herein. Littlejohn discusses a system involving prepaid utility services in which a customer can use a smart card with a prepaid amount or can provide other payments to an “interagent” who then obtains and provides for the services for the customer. This approach involves the use of a metering system to determine whether the customer has made adequate prepayments. However, the use of such metering systems requires additional expenditures to purchase and install such systems.

None of these conventional systems and methods fully addresses the provision of utility services to customers with poor or bad credit histories or scores, and the ability of such customers to obtain a more complete range of choices of utility services, rate plans and pricing. Moreover, these conventional systems and methods typically assume that the service can be terminated at any time when the customer has used up the amount of prepayment. In many regulated industries, this assumption is false. In other words, the service provider may have regulatory obligations that the provider must meet, even if and when the service provider has fulfilled its contractual obligations to the customer and/or the customer has breached his agreement to pay for the services. Moreover, the existing utility infrastructure, including the meters, often does not have the technical capability to measure real-time usage and automatically shut off utility services once the customer has used up the amount of prepayment.

None of the above inventions describe a billing system capable of enabling providers to bill in advance for estimated charges for services and requiring consumers to pay those estimated charges before the end of the consumption period, and for an adjusted amount to be billed based on the difference between actual charges and estimated charges.

### SUMMARY OF THE INVENTION

In accordance with a preferred embodiment of the present invention, methods, systems and apparatus are provided to allow a service provider to provide services to a customer who has a poor credit history or score and therefore poses a relatively high credit risk. In one embodiment, the service provider performs a credit check on a potential customer to determine the customer's qualification for enrollment in a rate program in accordance with the invention. If the customer qualifies, the provider enrolls the customer in a program by which the parties agree to terms involving billing and payment as detailed below. In such a program, the service provider bills the customer for an initial amount, such as an estimate of the charges for the service to be incurred in a first billing period. In one embodiment, this initial bill is sent shortly after the customer is enrolled in the program, the customer is connected to the service to be provided, and the provider begins providing the service to the customer. After the initial bill, the service provider then subsequently bills the customer for subsequent billing periods, with the billing for each period being an amount that in a subsequent period is determined by determining the actual amount of charges incurred during the preceding period, comparing the actual amount to the estimated amount previously billed and paid, and then adding or subtracting the difference between these amounts as appropriate (depending on whether the customer has paid more or less than the actual amount during such prior billing period) as a “true up” for the prior billing period, then adding or subtracting this amount to or from the amount to be billed to the customer for the subsequent billing period. With each bill, the service provider in this embodiment also sends a notice of disconnection, such that the customer is notified if the bill is not timely paid.

It is an object of the invention to provide billing methods and systems capable of enabling service providers to bill customers for an initial amount which is an estimate of the cost of a service during a first billing period, and to bill customers for subsequent amounts for subsequent billing periods in which the billed amounts include a “true up” of the amounts previously billed and the amounts actually charged.

It is another object of the invention to provide billing methods and systems which allow a utility service provider to provide service to a customer who poses a higher credit risk by minimizing the risk of nonpayment for services provided without requiring a deposit or initial fee from the customer before service is provided.

These and other objects of the present invention in its various embodiments will become readily apparent upon further review of the following specification and drawings.

### BRIEF DESCRIPTION OF THE DRAWINGS

FIG. 1 shows a flow chart providing an overview of the methods of a preferred embodiment.

FIG. 2 shows a flow diagram of customer communications according to one embodiment.

FIG. 3 illustrates an initial bill for an initial billing period according to one embodiment.

FIG. 4 illustrates a second bill for a second billing period according to the same embodiment as shown in FIG. 3.

FIG. 5 illustrates a third bill for a third billing period according to the same embodiment as shown in FIG. 3.

FIG. 6 illustrates an alternative third bill for a third billing period.

FIG. 7 shows an example of a form of disconnection notice.

FIG. 8 is a block diagram of a computer system in one embodiment.

### DETAILED DESCRIPTION OF THE PREFERRED EMBODIMENTS

The present invention includes methods, systems, and apparatus for a unique billing and payment approach that can be considered to combine elements of a prepay and postpay periodic billing approach for enabling service providers to bill in advance of service provision and thereby reduce the amount of postpay service provided before the service may need to be terminated. This allows the service provider to minimize the risk of nonpayment by minimizing the amount of service provided prior to a termination of service for nonpayment. By limiting credit exposure, the invention also allows the service provider to not require a customer deposit or a pre-payment prior to establishing utility service. In one embodiment, the system includes an accounting system for maintaining customer information and accounts, which is used to generate a first bill for a first period of service, then later bills for each subsequent period. The first bill includes an amount due for the estimated cost of service provided during the first period. The bill in each subsequent period includes an estimated cost of service provided during the period, the difference between actual charges incurred and the estimated charges paid for the previous period, and the difference between the balance due and any payments already received. The system includes methods for initiating and terminating customer enrollment in the billing system.

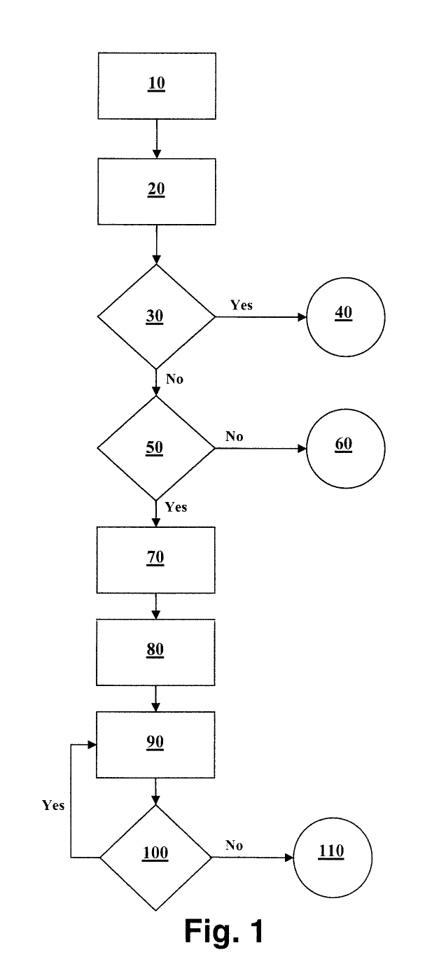

Referring first to FIG. 1, a flow chart of a preferred embodiment of the methods of the invention is shown. In FIG. 1, a customer first applies for service from a provider as step 10. In step 20, the provider examines the customer's application and, among other things, performs a credit check on the customer, thereby obtaining information about the customer's credit history or credit score. Next, at step 30, the service provider determines whether, based on the customer's credit history or score, the customer qualifies for the service provider's regular terms of service, in which case the service provider offers the customer a rate plan on such standard terms, as indicated in the diagram at 40. However, if the customer does not qualify for standard service, the service provider determines whether the customer qualifies for service based on the billing systems and methods in accordance with this embodiment of invention as indicated in the diagram at step 50. The service provider may decline to provide service to the customer as indicated at 60 in FIG. 1. If, however, the provider is willing to provide service, but not at the provider's normal terms, the provider then offers to provide service according to the new billing methods and systems of this embodiment. Once the customer has agreed to the terms of service, the service provider then connects the customer to the service and begins providing service, with these steps shown as 70 in FIG. 1. In the preferred embodiment, the service provider prepares and sends an initial bill to the customer as the next step 80.

Still referring to FIG. 1, the service provider prepares an initial bill for an initial billing period. Generally, the billing periods will be 30 days or one calendar month in length, but those skilled in the art will appreciate that other billing periods may be used. The amount of the initial bill is determined as an estimate of the service charges that will be incurred during the initial billing period as described in more detail below. Once the initial amount for the initial billing period is determined, the provider generates and sends the initial bill to the customer in step 80. In step 90 of FIG. 1, the provider calculates, generates and sends a subsequent bill to the customer for the next billing period. The amount of this subsequent bill is determined based on the actual charges for the service incurred during the initial billing period and the difference between the amount paid by the customer for the initial period and the actual amount of charges, together with an estimate of the charges for the subsequent billing period as described below in more detail. As explained below, the subsequent bill is to be paid relatively quickly once received, such as within 20 days of receipt, thus minimizing the risk of nonpayment for services provided by the service provider after the subsequent bill is sent. If the customer pays the subsequent bill on time, as determined by the provider according to the due date of the bill and indicated in step 100, the service provider continues to provide service and calculates, generates and sends subsequent bills for subsequent corresponding billing periods. However, if the customer fails to pay the subsequent bill on time, the service provider may terminate service to the customer as indicated by step 110 in FIG. 1. It is to be understood, however, the service provider may be subject to legal requirements that restrict or limit the service provider's ability to terminate service, and also that the service provider may choose to take other actions to collect payment in addition to or in lieu of terminating service.

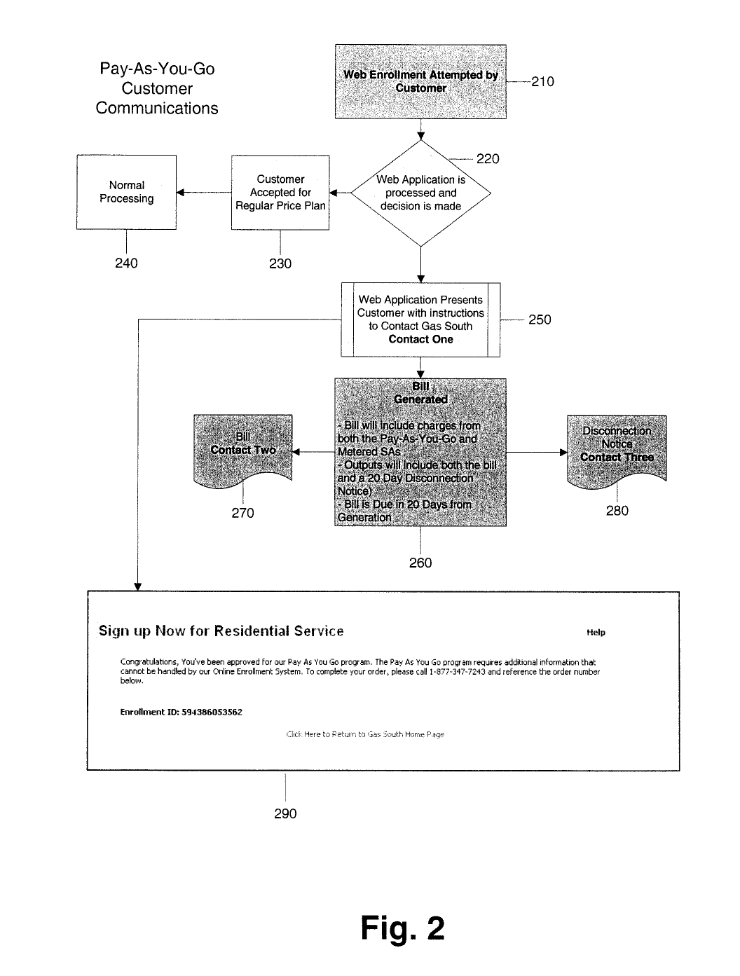

Referring now to FIG. 2, additional details regarding a preferred embodiment are shown. In FIG. 2, a customer applies for enrollment with a service provider via the world web at step 210. In this embodiment, the present billing system and apparatus is one of a variety of billing plans offered by the provider. For purposes of the following discussion, and in the preferred embodiment, the service provider provides natural gas service to a residence. However, the invention may be used in connection with other services and the customer need not be an individual or a residence, as those skilled in the art will appreciate. Still referring to FIG. 2, the customer provides information during enrollment step 210, such as name, address, social security number, contact information, and the like, and submits the same to the service provider via a computer connected to the Internet. The customer may submit such information by accessing a website on the Internet maintained by the service provider from a remote location, or the service provider may provide computer terminals in one or more locations for customers to use to submit such information. Those skilled in the art will appreciate that the customer may provide such information over the telephone or in person to the service provider representatives as well. Once the provider receives the application information from a customer, the provider then stores the information in a computer database and processes the information at step 220. In processing the application information, the provider obtains credit information regarding the customer, such as credit history, credit score, or the like. The provider can obtain such information via phone, over the Internet or otherwise via conventional means. As detailed below, we prefer to have a computer system programmed to automatically transmit appropriate information regarding the potential customer obtained from the customer's application to a credit bureau and automatically receive customer credit information, such as a credit score, back from the credit bureau, so that the computer system can automatically process the application. In step 220, the provider determines whether to accept the customer for one or more various rate plans. If the customer has a high enough credit score, for example, the customer may be accepted for a regular postpay rate plan, such as at step 230, in which case the provider so notifies the customer and enrolls the customer into the normal postpay rate plan at normal rates, connects the customer to the service, and begins providing the services, as indicated at step 240. Here again, we prefer to have such steps performed automatically by a preprogrammed computer system which is programmed to automatically provide appropriate information to the customer in response to the customer's submission of information to the provider's website.

In the event the customer's credit information is such that the customer does not qualify for a traditional rate plan or normal rates, such as due to the customer's poor credit history or credit score, the service provider may nonetheless conclude during step 220 that the customer qualifies for a modified payment and billing plan. In such event, the provider may offer service to the customer according to a modified rate plan (as described in more detail below) rather than simply reject the customer entirely. In such situations, the provider's computerized system is programmed to determine whether the customer nonetheless qualifies for the unique rate plan during step 220 and, if so, provides information to the customer at step 250.

We prefer to have the service provider's computer system programmed to present the customer in such situations with a message 290 such as that shown in FIG. 2. When the customer responds to the message 290 by calling the service provider, the service provider offers the customer the opportunity to enroll in the rate plan of the preferred embodiment as detailed below. Alternatively, the customer could respond to the message 290 by fax, email, or regular mail, among other approaches. As another alternative, the provider's computer system could be programmed to present the customer with a message (not shown) notifying the customer of the opportunity to enroll in the rate plan and obtain and provide information on the rate plan. In the preferred embodiment, the customer is notified at step 250 of customer's qualification for the new billing plan and receives the message 290, and then is provided additional details regarding the plan's terms and conditions when the customer calls in response to the message 290. If the customer accepts the terms and conditions for service, then (as noted above), the provider connects the customer's residence to the appropriate lines for gas service, and begins providing gas to the customer's residence. Those skilled in the art will appreciate that the customer already receiving the service may apply for service with a different provider. In situations where the customer is already receiving the service from another provider, then the customer need not be connected to a gas line, but instead a switch order is generated by the provider to the utility to indicate that the customer has transferred from one provider to another.

Still referring to FIG. 2, the provider in the preferred embodiment then generates an initial bill for gas service to be provided during the initial billing period at step 260. In a preferred embodiment, the provider at step 260 generates an initial bill for an initial billing period of 30 days or so. This initial bill is generated and sent shortly after the customer begins receiving service from the provider. In this preferred embodiment, the customer need not pay an initial fee when establishing service with the provider, such as a deposit or a prepayment to cover the amount of services for the initial billing period (or any other period, for that matter). This approach allows customers who may have little cash at the time to still sign up for services, such as may be the case shortly before the end of a pay period for the customer. In step 260, the bill generated by the provider's computer system will contain a bill for an amount to be paid by the customer for gas service to be provided during the initial billing period. This amount in this initial bill will be an estimate based on the then current rates for gas and the amount of gas usage expected during the initial billing period. The estimated amount of gas usage by the customer for the initial billing period can be an average amount of the consumption of residential customers of gas service in that area for the billing period. Such average consumption amounts typically vary for gas service, with higher consumptions averages in winter months than in summer months. Data on average gas consumption rates for residential customers is available from conventional sources. Those skilled in the art will appreciate that additional or other information may be used to estimate the customer's likely consumption, such as past usage history by the customer if available, the size of the residence or other information about the residence, the specific area (such as by zip code) in which the residence is located, and other information.

A conventional residential natural gas bill for a gas marketing company has both “pass through” charges, which are billed and collected by a service provider who markets gas service (the marketing company), and are paid to a gas utility by the marketing company, and charges which are billed and collected by the marketer and stay with the marketer. The pass through charges and the marketer charges have both fixed components (e.g., wherein each customer pays the same amount in a particular month) and variable components (e.g., wherein each customer is billed according to either the customer's monthly consumption or the customer's allocation of capacity to serve peak demand (the “Demand Billing Determinant” or “DBD”). In much of the Georgia market, for example, Atlanta Gas Light (“AGL”) serves as the gas utility, and the DBD is called the “Designated Design Day Capacity” (“DDDC”). The DDDC in the AGL market is the capacity designated (for billing purposes) to serve a particular customer on the severe weather day the relevant gas transmission and distribution system is designed to meet. In an electric system, the DBD would typically be the customer's peak demand increased so as to include losses and a reserve margin.

We have found that monthly consumption is highly correlated to DBD and residential profiles (typical usage patterns) are relatively consistent (e.g., for residential natural gas, high consumption in the winter from heat and low consumption in the summer). Therefore, consumption for a particular month can be estimated from the customer's DBD. Fixed charges (e.g., charges that do not vary by DBD or consumption) are typically set by a gas utility's tariff or the marketer's terms and conditions. Charges that vary by DBD do change monthly, but can be accurately predicted with the DBD. Charges that vary by consumption can be estimated from the DBD and the typical residential consumption for that month at that DBD level and the estimated per them rate. Using this information, an estimated bill for a customer of X DBD in month n is: Fixed Chargesₙ+(X DBD*typical use per DBD in month n for a residential customer)*forecast rate/therm+(X DBD*tariff charges per DBD). For any month for a customer of X DBD, the formula for estimating the bill amount can be reduced to A+B*X, where A are the fixed charges that do not vary with DBD or consumption and B is the factor that, when multiplied by the DBD, yields an estimate of the charges that do vary by consumption and DBD. For new customers who do not yet have a DBD, we believe that an average DBD is adequate for estimation purposes since the distribution of DBDs is not wide. For example, a typical DBD for a residential customer who is a candidate for the billing program of the preferred embodiment in Atlanta, Ga. will be expected to use about 1.1 dekatherms of natural gas on design day, a very cold day meeting the specific conditions the AGL (or gas utility's) transmission and distribution infrastructure was designed to serve. Also, because there may be some problems in the gas utility's DBD calculation in which the utility sets the DBD very low, a minimum DBD is used in the preferred embodiment. This minimum DBD will help ensure that the estimated bill for one of the customers with a very low DBD is not consistently understated.

Determining the A and B components of the estimating formula requires several processes. In the preferred embodiment, we use a preprogrammed computer system to calculate the components A and B, and generate the appropriate estimates of amounts for billing purposes, in accordance with the following. The estimating computer system should be programmed to account for all the components of the applicable tariff for gas service, how those components are subdivided into fixed (e.g., independent of customer usage) and variable (e.g., dependent on customer usage), as well as how the components change by calendar day. In the preferred embodiment, the first process is the determination of a typical usage (which may be determined in units of therms or kilowahtthours or other measure) by day for a set level of DBD. For example, on a day in early January, a customer with a DBD of 1 dekatherm may have gas usage of 3.2 therms, and on a day in early June the same customer may use 0.4 therms. The forecasted daily usage values for the following billing period can be summed to determine the estimated therms of usage for which the bill amount should be estimated.

The second process in determining the A and B components is the determination of the specific date on which a customer is attributed capacity and other fixed costs. In the AGL market for cost allocation and regulated utility billing reasons, every customer in the market is linked with a particular energy marketer on a given day in the month (such that the regulated utility's revenue requirements are properly met), and a customer's status on that day of the month will impact the customer's billing during the period for which a bill is estimated. Customers on a gas marketer's list of allocated customers for a given period will result in charges to the marketer which should be included in the estimated bill.

A third process in determining components A and B is determining the variable (e.g., per therm or per kiloWatthour) rate that will apply to the customer given the start date of the customer's meter reading cycle or the customer's enrollment with the marketer. The applicable rate rules likely will vary from jurisdiction to jurisdiction, but an energy marketer will typically be required to bill a customer at the rate in effect at the beginning of the meter reading cycle or in effect when the meter is connected (in the case of a customer previously not connected to the grid). The rate set should be sufficient to cover the default risk for the customer class that will be served by this program in the preferred embodiment. We believe that the rate should include a premium above the “standard rate” available to customers that are not credit challenged. The premium can be calculated to cover the additional cost of credit risk and the greater amount of service these customers usually require.

The fourth process in determining components A and B in the preferred embodiment combines these three earlier processes, calculating by each day the A and B components that accurately estimate the bill for customers enrolling on that day using algebraic formulas.

To determine the estimate for the billing amount, we prefer to base it on the expected consumption per DBD for the billing period, the expected DBD per customer, the fixed charges per customer, and the variable charges per DBD. To determine the estimated amount for a given billing period, we first determine the expected consumption per DBD for the billing period, then determine the expected DBD per customer, then determine and apply a premium over standard rates for the service for that period, determine the fixed charges per customer (component A as described above), and then determine the variable charges per DBD (component B as described above).

We prefer to estimate the consumption for the next billing period by projecting the monthly consumption per DBD and summing the monthly consumption for the relevant number of days of future months. Multivariate linear regression analysis can be used. A data set of a large sample (we consider a few thousand as sufficient) of residential customers is compiled with:

a) consumption in the billing period (typically about 30 days, but not necessarily from the first to the last day of the month) divided by the DBD of each customer for the past 12 or 24 months,

b) heating degree days (HDD) per billing period (e.g., the sum of (65 minus the midpoint between daily high and low temperatures for the month) excluding midpoints above 65); and

c) the number of days in each billing period which fall in each month. The dependent variable of the regression analysis is the consumption per DBD. The independent variables are HDDs and seasonal “dummy” variables. We use the seasonal variables to more accurately reflect the observed behavior that the response to cold weather (high HDDs) is greater in the coldest part of winter than it is in the spring and fall. For the different seasons, the regression yields a formula of:

Consumption per DBD=a+b1*(HDDs Season 1)+b2*(HDDs Season 2) . . . for all the seasons.

These formulas are applied to each month using HDDs from normal weather conditions (such as by averaging historical weather rather than using the particular months in the regression analysis) to determine normal weather usage by month per DBD. These monthly numbers are then converted to total consumption by considering the part of each month's load that is reflected in a particular bill. The calculation is illustrated in the following example. Suppose a customer is to be billed in the Pay-As-You-Go rate program described herein on April 24 of a given year. In our preferred embodiment, a billing date of April 24 would result in a billing period running from April 20 through May 24 (with April 20 selected as it would be the typical date of last meter reading, assuming four days of processing and transition time from meter read to billing, until May 24, which would be the next billing date). For simplicity in the billing system, a customer enrolling on April 24 will be assigned an estimated bill from April 20 through May 24 consistent with that of customers already enrolled in the program. The estimate for an initial billing period will also, in this example, use the projected consumption for April 20 through May 24. Those skilled in the art will appreciate that utility services such as providers of natural gas keep track of the days on which their customers' meters are read to determine actual usage, and that, for any given customer, the day on which the meter is read need not be the date that is the beginning or ending of a corresponding billing period. With those dates of required coverage for the estimate for the billing period, April 20 through May 24, the bill should include an estimate for the customer's consumption for 33.3% of April and 77.4% of May. Based on historical information regarding average customer consumption for service in that area, a chart can be prepared which indicates the average amount of dekatherms per DBD consumed by a customer in a given month, such as shown in the Table 1 below.

TABLE 1

| | | dekatherm |
|---|---|---|
| | Days | per DDDC |
| January | 31 | 9.92 |
| February | 28 | 7.46 |
| March | 31 | 5.46 |
| April | 30 | 2.65 |
| May | 31 | 1.39 |
| June | 30 | 1.16 |
| July | 31 | 1.10 |
| August | 31 | 1.11 |
| September | 30 | 1.23 |
| October | 31 | 2.37 |
| November | 30 | 5.14 |
| December | 31 | 9.47 |

Table 1 reflects an example of the typical average customer consumption in dekatherms per DDDC for each month during the year in the Atlanta, Ga. area. For a bill prepared as of April 24 and covering the period April 20 through May 24, 1.96 dekatherms per DDDC is the projected usage by the customer for the billing period. This can be determined by adding (0.333×2.65) and (0.774×1.39), or 0.88+1.08=1.96 in this example, to get the total expected average consumption by a customer for the April and May days included in the initial billing period (e.g., 33.3% of April and 77.4% of May is included in the billing period in this example) starting April 20.

Once the systems and methods with the Pay-As-You-Go rate program described herein have been implemented in a particular location, additional information regarding the customers in that rate program in that location will become available and can be stored and used to estimate the relevant DBD for such customers and such program. Until the average DBD of customers enrolled in a given location can be observed, however, we believe that the DBD should be estimated. We believe that the DBD of the regulated provider in the relevant location is a reasonable measure from which to estimate DBD, as customers who are credit challenged are otherwise likely to need to obtain service from the regulated provider in a given location. The average DBD for a customer of a regulated provider is typically available through public filings by the regulated provider. In the Atlanta, Ga. area, for example, the typical DBD value for a customer of gas service from Atlanta Gas & Light (the regulated provider in the Atlanta area) may be 1.1 dekatherms.

In our experience, we have found that credit challenged customers who are likely candidates for a rate program and the systems and methods described herein, such as the “Pay-As-You-Go” rate program, have a higher cost to serve than standard customers. We believe that this is so for a number of reasons, including:

a) such customers tend to have a higher default rate on bills and therefore tend to present a higher cost of bad debt,

b) such customers tend to call the provider's Call Center more often and therefore tend to present higher administrative costs to the provider,

c) such customers tend to move more often and therefore the administrative costs of enrollment tend to be spread over a smaller number of months, and

d) such customers tend to have lower average use of the gas service than standard customers and therefore the costs which do not vary with volume of use, such as billing costs, tend to be greater on a per therm basis.

Natural gas retail service is conventionally priced with two price components: a monthly customer service charge and a per therm charge. For example, a standard rate might be $5.95 per month and $1.00 per therm used by the customer in that month. A premium can be added to each of these amounts to help cover the increased costs presented by customers who are credit challenged, net of any additional benefit of late fees. (To some extent, a higher incidence of late fees imposed on such customers may partially offset these higher costs presented by such customers, although the late fees also need to be collected.) In addition to the items listed above that affect the determination of the appropriate premium, we also view the premium as a function of the credit score range across which customers are accepted in the rate program, such as the Pay-As-You-Go rate program described herein. We believe that the appropriate premium should be determined in a way so that the average customer at the least credit-worthy end of the range of acceptability for the new rate program described herein is not unprofitable. This approach helps ensure that the customers throughout the rest of the “Pay-As-You-Go” rate program will be profitable and the rate program can be sustained. In our example, then, we add $0.05 per therm to the published variable rate of $1.38 per therm for a variable rate of $1.43 per therm for a customer in the “Pay-As-You-Go” rate program. We also add an appropriate amount to the fixed charges for the service, which are included in the customer service charge amount of $9.95 per customer per billing period.

The fixed charges per customer in the A component of the estimate for billing can be determined by summing the fixed per customer charges (those that do not vary with consumption), composed of the charges from the local distribution company and the retail marketer customer service charge. An example of such fixed charges and sample calculation are provided below in Table 2.

TABLE 2
Fixed Charges

| | | |
|---|---|---|
| Customer Charge | $9.05 | per Customer |
| Meter Reading Charge | $0.71 | per Customer |
| Social Responsibility Charge | $0.29 | per Customer |
| Customer Education Charge | $— | per Customer |
| Pipeline Replacement Program | $1.29 | per Customer |
| Gas South Customer Service Charge | $9.95 | per Customer |
| Total | $21.29 | |

As indicated in Table 2, in our example, the fixed charges for a customer are $21.29 per billing period.

Next, we determine the variable charges per DBD for a customer. Generally, there are two components of B, including those that are a direct function of DBD and those that are an indirect function of DBD. In our example, the direct DBD charges for a customer in a given billing period are set by the regulated provider, AGL, as shown in Table 3 below. (In Table 3, the DBD charges are listed as shown as charges per dekatherm of DDDC, which is the AGL term for DBD).

TABLE 3
Variable Charges

| | | |
|---|---|---|
| Design Day Capacity Charge | $1.92 | per dekatherm of DDDC |
| Peaking Charge | $0.94 | per dekatherm of DDDC |
| Franchise Recovery Fee | $0.53 | per dekatherm of DDDC |
| Environmental Response Costs Charge | $0.76 | per dekatherm of DDDC |
| Total | $4.15 | |

As shown in Table 3, the variable charges total $4.15 per dekatherm of DDDC.

The component of B that is an indirect function of DBD is the component that captures the charges for the customer's consumption of gas. In the sample calculation for April 20 through May 24 in our example, we have already estimated the customer's consumption for the billing period as 1.96 dekatherms per dekatherm of DDDC, and we have already determined that the current rate per therm is $1.43 for the service. The product of those two components yields a rate of $28.03 per dekatherm of DDDC and adding this amount together with the previously determined total of variable charges ($4.15 per dekatherm of DDDC as shown in Table 3), results in a value of $32.18 for component B. Referring back to the formula for estimating the amount to be billed, A+B*X, it can be seen that the estimated amount for the initial bill in our example should be $21.29+($32.18*1.1)=$56.69.

For ease of implementation in the computer billing systems of the service provider, different days during the month can be identified for updating the A and B components. In the preferred embodiment, the updates would occur whenever retail prices change, with the change in the allocation date (the date on which customers are allocated to different marketers for the following period), and when there is a sufficient change in the expectation of use. Those skilled in the art will appreciate that the desirability of the update based on changes in these various components and factors should be weighed against the costs and operational risks of frequent changes in the A and B coefficients. Those skilled in the art will also appreciate that other data and factors may be used, that the A and B components may be weighted differently, that the amount of the appropriate premium may vary (such as by estimated usage and/or by the perceived level of credit risk), and that other formulas may be used to estimate a customer's billing amount in addition to or in lieu of the manner of determining the same as described for the foregoing embodiment.

In step 260 of FIG. 2, the bill also includes a disconnection notice portion 280, as well as the bill portion 270. In the preferred embodiment, the disconnection notice 280 notifies the customer that the service will be terminated if the customer does not pay the amount billed within five days after the bill due date. The time to pay may vary, but we currently view a 20 day payment period as the preferred embodiment. The disconnection notice 280 is important because a gas service provider typically cannot disconnect a customer or otherwise terminate service without first giving notice of nonpayment and the impending termination of service to the customer. By giving such notice 280 as part of each bill sent to the customer, the provider is able to keep the amount of services provided for which no payment is received at a minimum without resorting to requiring a deposit or prepayment from the customer.

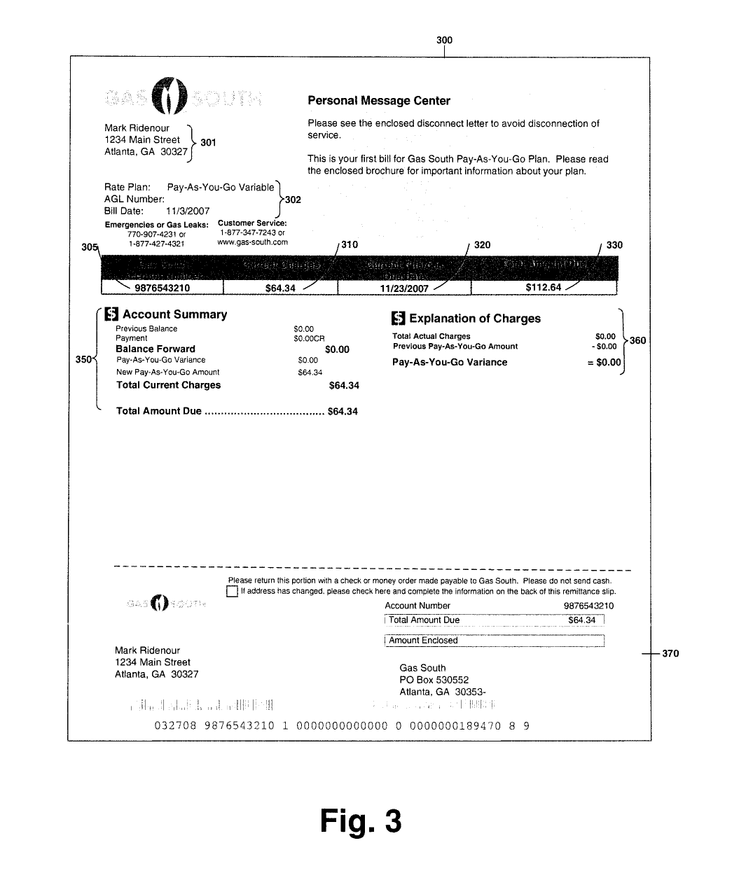

Referring now to FIG. 3, additional detail is provided regarding an initial bill such as described above. In FIG. 3, an illustration of an initial bill 300 generated and sent by the provider to the customer is shown. The bill 300 includes a number of data fields that are conventional for bills sent to gas service customers, such as the customer name and address information 301, as well as a detachable stub 370 that is pre-addressed for return to the provider along with payment. In addition, the bill 300 includes a data field for customer account information 302, which includes the name of the rate plan applicable to the customer, a field for an AGL number (shown as blank in FIG. 3, as in this example, the customer is new and does not yet have an AGL number) identifying the particular location to which gas service is provided, as well as the date of the initial bill 300. (As noted above, “AGL” stands for Atlanta Gas and Light, a gas utility in Georgia. Other account identifiers may be used in connection with other service providers.) The bill 300 also includes data fields 305, 310, 320 and 330, respectively, for the customer's provider account number, the current charges to be paid, the due date for the current charges billed in bill 300, and the total amount due. In addition, the initial bill 300 includes an account summary field 350, which includes a balance forward amount based on the previous balance and the amount to be credited towards payment of bill 300 ($0.00 as shown in bill 300 in FIG. 3 because this illustrates an initial bill for a new customer), as well as amounts for a “Pay-As-You-Go variance” and a “Pay-As-You-Go amount,” shown as $0.00 and $64.34, respectively, in the bill 300. (It will be understood that the following discussion with respect to bills 300, 400, 500, and 600 and the examples and amounts therein are independent of the preceding example for determining the estimated billing amount.) The new Pay-As-You-Go amount is the estimated amount of charges that the new customer will incur during the initial billing period. This amount is also shown as the total amount due in the field 330 and in the detachable stub 370 of bill 300.

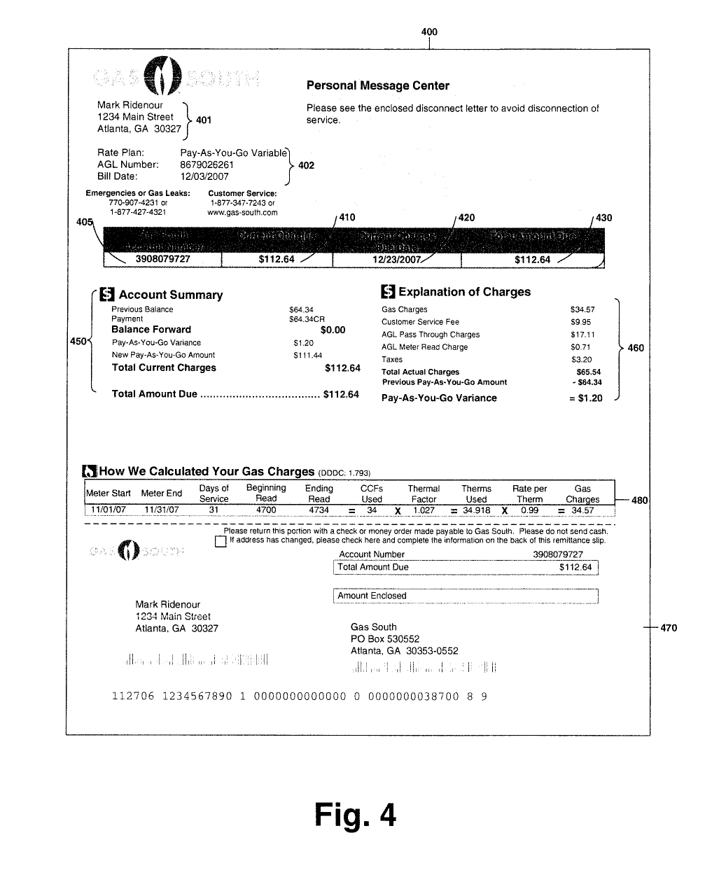

Referring now to FIG. 4, a second bill 400 for a customer enrolled in the rate plan of the preferred embodiment is shown. As illustrated in FIG. 4, in a preferred embodiment, in the billing period after the initial billing period, a subsequent bill 400 is generated. As indicated in FIG. 4, bill 400 has customer information 401 and 402 for the same customer, as well as a detachable payment stub 470. The account information field 402 includes the AGL number for the customer. The bill 400 also includes account summary information 450, which includes the initial estimate for the initial billing period (shown as $64.34) and reflects that the customer has paid this amount, but no additional amounts, such that the balance forward amount is $0.00. The account summary information 450 also reflects a Pay-As-You-Go variance of $1.20, as well as a new Pay-As-You-Go amount of $111.44, for total current charges and, in this situation, a total amount due, of $112.64.

The explanation of charges information field 460 of bill 400 provides the customer with a breakdown of the charges incurred during the preceding billing period for the service, which in this case is the initial billing period. For this bill 400, the total actual charges for the preceding billing period are shown to total up to the amount of $65.54. Because this amount of actual charges exceeds the amount of the preceding bill and the amount paid by the customer, the bill 400 also includes a Pay-As-You-Go variance of $1.20, shown in both fields 450 and 460, which is the difference between the amount of actual charges and the amount of the estimated charges for the preceding billing period (again, the initial billing period in this illustration). Thus, the bill 400 includes a variance or “true up” portion to account for the differences between the amount previously paid by the customer based on an previous estimate and the amount actually due based on the customer's actual usage. The basis for the amount of actual charges for service during the preceding billing period is provided in a services calculation field 480 in bill 400. As shown in FIG. 4, the amount of actual charges is based on the meter readings for the gas service at an initial time and at a second time, with the meter readings reflecting the customer's usage of the gas service during that time period. The amount of cubic feet of gas used during this period is provided as the CCFs Used field, a thermal factor is applied, and the amount of Therms Used is provided. The fee rate per Therm is them applied to the amount of Therms Used to get the amount of gas charges for the preceding billing period. As indicated in explanation of charges field 460, the customer is also billed amounts including a service fee, taxes, and certain pass through charges. Those skilled in the art will appreciate that charges for gas service may include other factors, and that charges for other services may be based on other factors as well.

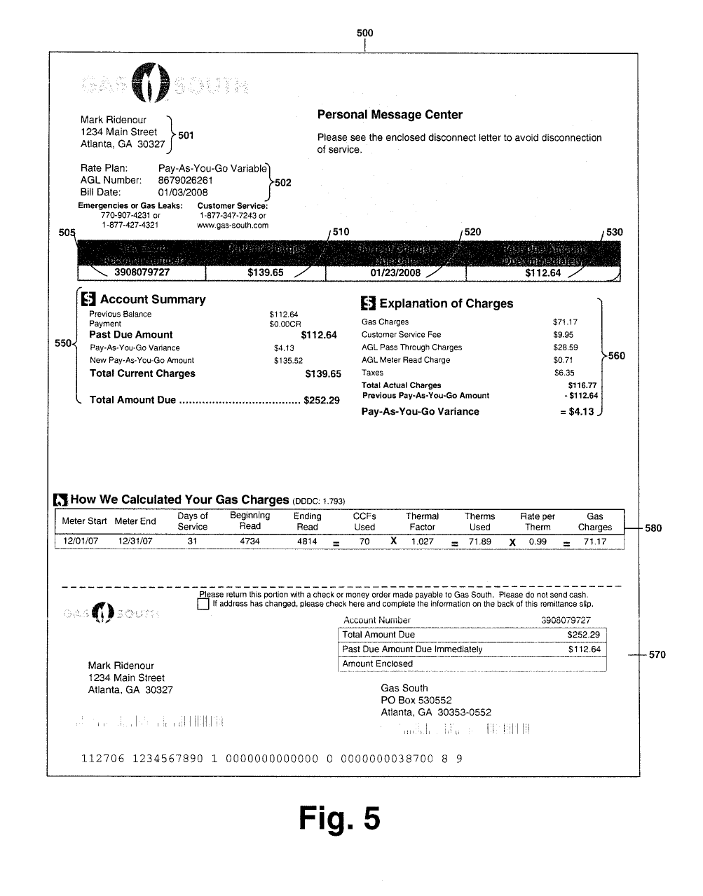

Now referring to FIG. 5, an illustration of a third bill 500 to the customer is provided. As indicated in FIG. 5, bill 500 is for a third billing period for the same customer who was the subject of bills 300 and 400 discussed above. Bill 500 also includes customer information 501 and 502 for the same customer, as well as a detachable payment stub 570. The bill 500 also includes account summary information 550, which includes the estimate for the preceding billing period (as shown in field 401 in FIG. 4) and reflects that the customer has not paid this amount, such that the balance forward amount in field 550 of bill 500 is $112.64. The account summary information 550 also reflects a Pay-As-You-Go variance of $4.13, as well as a new Pay-As-You-Go amount of $135.52, for total current charges and, in this situation, a total amount due, of $252.29. The explanation of charges information field 560 of bill 500 provides the customer with a breakdown of the charges incurred during the preceding billing period, which in this case is the second billing period. For this bill 500, the total actual charges for the preceding billing period total up to the amount of $116.77. Because this amount of actual charges exceeds the amount of the preceding bill and the amount paid by the customer (shown as $0.00 in bill 500 in this example), the bill 500 also includes a Pay-As-You-Go variance amount of $4.13, which is the difference between the amount of actual charges and the amount of estimated charges for the preceding billing period (again, the second billing period in this illustration). The basis for the amount of actual charges for service during the preceding billing period is provided in a services calculation field 580 in bill 500. As shown in FIG. 5, the amount of actual charges is based on the meter readings for the gas service at an initial time and at a second time covered by the billing period for bill 500, with the meter readings reflecting the customer's usage of the gas service during that time period.

With respect to bill 500 in FIG. 5, the customer's past due status may generate further action by the provider. In a situation, such as that illustrated in FIG. 5, the provider may choose to continue to provide service even if the customer has not paid a bill when due. In this example, the bill 500 reflects that the service provider continued to provide service to the customer even though the customer did not timely pay bill 400, as reflected the payment of $0.00 in the account summary field 550.

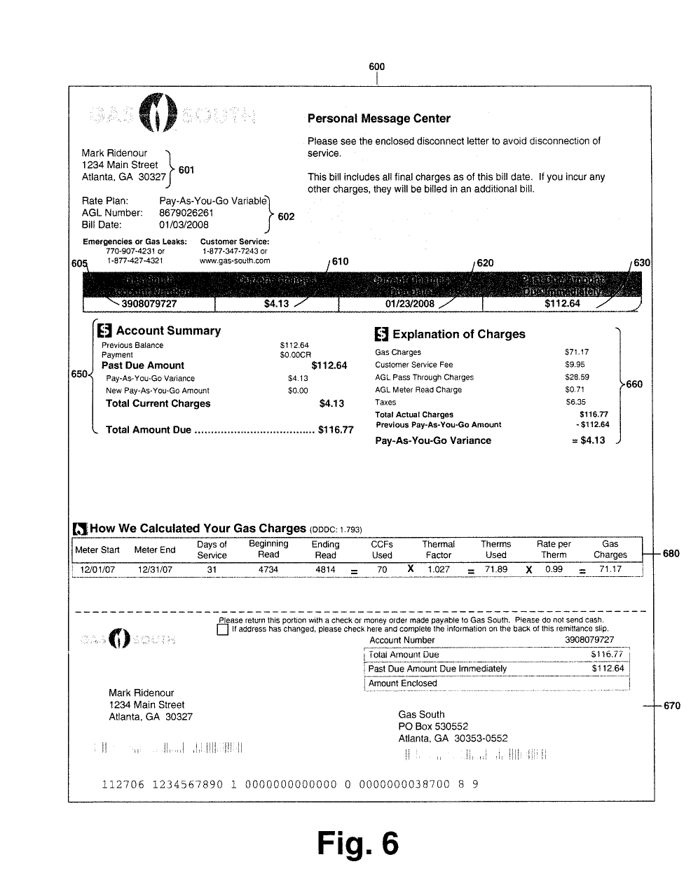

Referring now to FIG. 6, an illustration of an alternative third bill 600 to the customer is provided. As indicated in FIG. 6, bill 600 is for a third billing period for the same customer who was the subject of bills 300 and 400 discussed above. Bill 600 also includes customer information 601 and 602 for the same customer, as well as a detachable payment stub 670. Like bill 500, the bill 600 reflects that the customer has not paid the prior amount billed in the preceding billing period, as shown by the $0.00CR entry for payment in field 650. Bill 600 also shows that the amount of actual charges for the service during the preceding billing period was $116.77, as shown and explained in field 660 of bill 600. In bill 600, then, the balance forward amount in field 650 of bill 600 is $116.77, which includes the previously billed amount of $112.64 plus the variance between the estimated amount previously billed and the actual amount of charges. The explanation of charges information field 660 of bill 600 provides the customer with a breakdown of the charges incurred during the preceding billing period, which in this case is the second billing period. For this bill 600, the total actual charges for the preceding billing period total up to the amount of $116.77. As shown in FIG. 6, the amount of actual charges is based on the meter readings for the gas service at an initial time and at a second time covered by the billing period for bill 600, with the meter readings reflecting the customer's usage of the gas service during that time period.

Referring to both FIGS. 5 and 6, it will be seen that the bill 600 in FIG. 6 does not include a new “Pay-As-You-Go” amount (e.g., the amount shown in $0.00), whereas bill 500 in FIG. 5 shows a “New Pay-As-You-Go” amount of $135.52. This distinction illustrates the differences between a final bill, such as illustrated in FIG. 6, and a non-final bill, such as illustrated in FIG. 5. even though both bills 500 and 600 reflect nonpayment by the customer. The bill 600 in FIG. 6 illustrates a final bill that includes a “true-up” for the actual charges for service provided before the provider ceases providing service to the customer, but does not include any new amounts due to reflect the fact that the provider will not be providing further service to the customer.

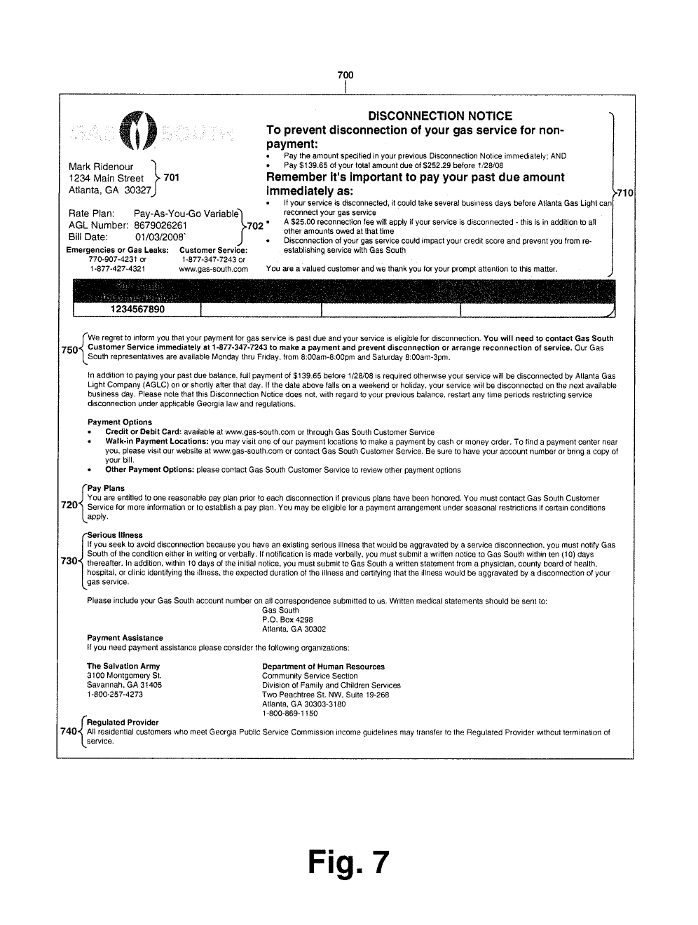

In the preferred embodiment, a disconnection notice 700, such as the one shown in FIG. 7, is generated and provided to the customer with each bill, such as those shown in FIGS. 3, 4, 5, and 6. The disconnection notice 700 may be generated by the computer system automatically and sent with each bill. Alternatively, the computer software may be programmed to allow the provider to selectively determine whether or not to generate and send a disconnection notice 700. For example, the provider may choose not to send a disconnection notice 700 if the amount overdue is small and the overdue amount is the first time that the customer has not paid in a timely fashion. Alternatively, if the overdue amount is large or if the customer is overdue for a third time, for example, the provider may choose to send a disconnection notice 700. Those skilled in the art will appreciate that the computer system can be programmed to generate a disconnection notice 700 based on parameters selected by the service provider, and such parameters may vary among providers.

Still referring to notice 700 in FIG. 7, it can be seen that the notice 700 includes customer information 701 and account information 702, as well as a field 710 explaining the customer's options for payment and the timing required for payment to avoid disconnection or termination of service. In addition, the notice 700 includes information about a customer's potential eligibility for a payment plan in field 720, as well as a field 730 notifying the customer about the possibility of delaying disconnection or termination due to a serious illness. The notice 700 also notifies the customer that the customer may be able to switch service to a regulated provider without a termination of service in field 740. Those skilled in the art will appreciate that other or additional data fields and information may be provided to the customer as desired by the provider and/or as required by law. Such other and/or additional information may vary depending on the jurisdiction involved and the applicable legal requirements, as well as the type of service involved, as some services may be more or less regulated than others.

Those skilled in the art will appreciate that, if a customer is provided with the option to use a payment plan that involves averaging the estimated annual costs of service over a twelve month period, that the bills generated and provided in such an embodiment can use the monthly average in lieu of the estimated amount to be billed for the current billing period. In addition, the monthly average amount based on such an approach can be added to or used together with an estimated amount for a billing period as desired.

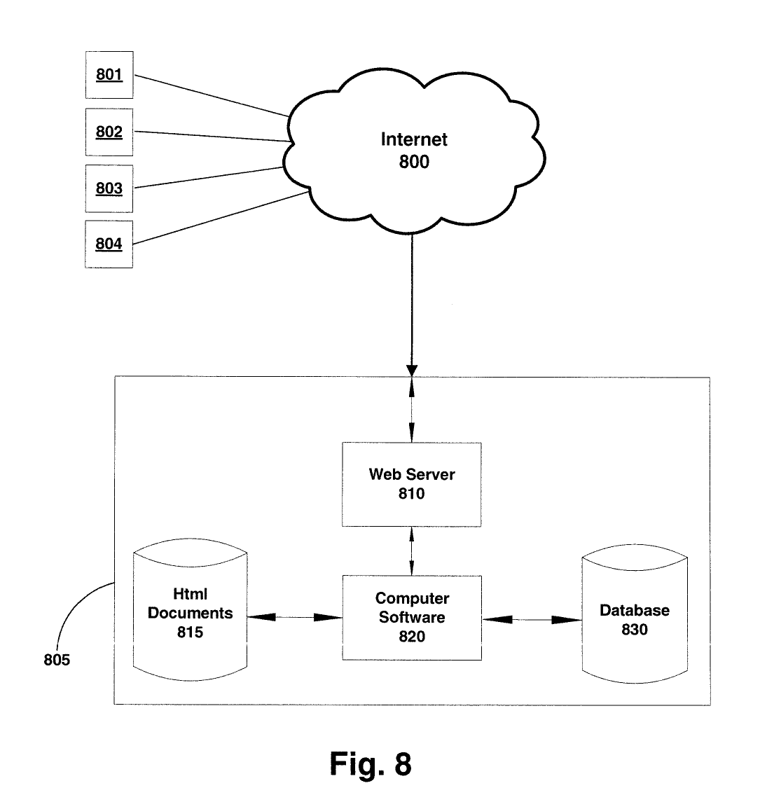

Those skilled in the art will also appreciate that many of the steps described above, as well as the bills 300, 400, 500, and 600, as well as the disconnect notice 700, can be automatically handled by a preprogrammed computer. FIG. 8 provides a block diagram of a computer system 800 which is useful for implementing the methods previously described.

Referring now to FIG. 8, a block diagram of a system and apparatus of an embodiment of the invention is shown. As shown in FIG. 8, a computer system 805 is provided. Computer system 805 can be of a conventional type of personal computer or server with an operating system, memory, and the like. The computer system 805 preferably has a connection to the Internet 800 as well, allowing computer system 805 to transmit and receive information via the Internet. As illustrated in FIG. 8, the computer system 805 has a web server component 810, as well as software 820 which may be executed on computer system 805 to perform as described. In addition, computer system 805 includes a database 815 comprising html documents for a website to be provided by computer system 805, as well as a customer database 830. The customer database 830 includes information about customers of the service provider, such as name, address, identifying information (such as a social security number), contact information, account information, including information regarding billing and payment history, account status (e.g., current, past due, amount due, amount delinquent, and so forth) for each customer of the provider for the rate plan.

Also indicated in FIG. 8 are computers 801, 802, 803, and 804. The computers 801-804 represent computers of customers and potential customers of the service provider, although such computers could also be publicly available computers, such as at a public library, or they could be provided by the service provider. As shown in FIG. 8, computers 801-804 are also connected to the Internet 800. A customer may use one of computers 801-804 to visit a website of the service provider which is provided by the computer system 805. In one embodiment, the website is interactive, such that a potential customer may use one of computers 801-804 to access the website (which can be provided using some or all of the html documents in database 815), and submit information if the customer is interested in enrolling for service with the provider. As detailed above, the computer software 820 can be programmed so that, upon receipt of an enrollment application from a potential customer, the computer system 805 stores the information received in the customer database 830, and requests a credit report for the customer from a third party's electronic interface (not shown). The computer system 805 is configured with software 820 to receive the credit report and, based on the credit information received, offer one or more rate plans to the customer or, if the customer's credit score or other information so indicates, will decline to offer service to the customer. The computer system 805 is programmed to store information indicating what plan(s) were offered and/or whether the customer was declined service.

If the customer is offered service, the computer system 805 can be programmed to automatically provide the customer with appropriate rate plan information and terms and conditions for electronic acceptance by the customer, all via the Internet 800. If the customer accepts the offered terms and conditions, the computer system 805 is programmed to so note and stores such information in the database 830. The computer system 805 is also programmed so that, when a new customer account is opened in accordance with the payment plan of one embodiment of the invention as described above, the computer system 805 sends appropriate notices to the customer and to the provider so that service is scheduled and provided, and if needed the customer is connected to the gas lines for gas service, such as by automatically sending an email with job information to the correct personnel. In addition, the computer system 805 is programmed so that an initial bill will be prepared in accordance with the methods described above, generated and then sent to the customer. As detailed above, the initial bill will be for an amount estimated to be the customer's usage. The current rates for use, as well as the data used in generating the estimate, together with the form of the bill to be sent, can all be stored in database 830 on computer system 805 and automatically generated by the by software 820 executing on the computers system 805. Similarly, the computer system 805 is programmed to store payment information, generate and send additional bills for subsequent periods, and provide any past due and disconnection notices if and when desired by the service provider, as described above. As with the initiation of service for a new account, the computer system 805 can also be programmed to automatically generate appropriate job information and send the same, such as by email, to appropriate personnel to arrange for the disconnection of the customer's service, such as for nonpayment or the customer's decision to switch service, or the like.

If desired, the computer system 805 can also be programmed to provide bills and notices to the customer as desired over the Internet 800, such as via email or the like which a customer can then read at any one of computers 801-804. Those skilled in the art will also appreciate that the computer system 805 can be programmed so that customers can view their corresponding account information via the Internet 800 and, if appropriate, can make payments to provider via the Internet 800 as well.

It will be recognized by those of skill in the art that this accelerated billing approach allows for a faster disconnection timeframe and lower bad debt exposure for the service provider than would otherwise be available in a conventional post pay billing system As a result, the service provider may be able to offer more favorable pricing and terms, including no deposit or pre-payment requirements and lower rates and service charges, than what would otherwise be economical. It should be noted that in the event of late payment, the customer will also likely benefit in that application of the preferred embodiment should result in the amounts in arrears being lower than would be the case in accordance with a conventional post pay billing system. This also should prevent the customer from falling far behind in the customer's bills and assists in budgeting and planning. The present invention, and the embodiments described, offers the advantage of allowing a first estimated amount of service to be billed and paid shortly after service begins, and a bill in a later period to correct in case the estimated exceeds or falls short of actual use.

Those skilled in the art will appreciate that the foregoing detailed description of the invention in its various embodiments is illustrative only, and that changes may be made to various aspects and features of the methods and systems of the invention without varying from the scope of the invention, which is defined by and to be measured only by the claims.

1.-12. (canceled)

13. A system for billing a customer for utility services, comprising:
a computer comprising a database for storing customer information corresponding to one or more customers of a utility service, wherein said computer is connected to the Internet and can receive and transmit information via the Internet; and
software that is executable by said computer, wherein said software is programmed to generate an initial bill for an amount to be paid for a utility service for an initial billing period when a new customer account is entered in the database and wherein the initial amount is estimated based at least in part on an average consumption rate for gas service in at least one area, at least in part on at least one fixed component, and at least in part on a capacity allocation corresponding to the customer by a distributor for the at least one area, and to generate a subsequent bill for a second amount to be paid for a utility service for a second billing period, wherein the second amount is based at least in part on a customer's actual usage of the utility service during the first billing period and the difference, if any, between the amount previously paid by the customer for the initial billing period and the actual usage amount, wherein the customer is provided with the utility service prior to a payment for the utility service.

14. (canceled)

15. (canceled)

16. The system according to claim 13, wherein the at least one fixed component comprises an amount based on the customer's allocation of the cost associated with the designated design day capacity.

17. The system according to claim 16 wherein said software is programmed to generate a disconnect notice corresponding to each bill.

18. The system according to claim 17 wherein the variable component comprises the current rate for natural gas for a given market.

19. (canceled)

20. The system according to claim 13 wherein the initial bill is generated without requirement of a pre-payment from the customer.

21. A system for billing a customer for gas services, comprising:
a computer comprising a database for storing customer information corresponding to one or more customers of a gas service, wherein said computer is connected to the Internet and can receive and transmit information via the Internet; and
software that is executable by said computer, wherein said software is programmed to enter a new customer account in the database without a requirement for a payment corresponding to the account, generate an initial bill for an initial amount to be paid for a gas service for an initial billing period, wherein the initial amount is estimated based at least in part on an average consumption rate for the gas service for a geographic area, wherein the average consumption rate is based on at least in part on a measure indicating the customer's allocation of capacity to serve peak demand for the area and a measure corresponding to usage in normal weather which is based in whole or in part on past usage and weather data and corresponding variations in Heating Degree Days, and wherein the initial amount is estimated based on at least in part on one or more fixed charges, generate a subsequent bill for a second amount to be paid for a gas service for a second billing period, wherein the second amount is based at least in part on a customer's actual usage of the gas service during the first billing period and the difference, if any, between the amount previously paid by the customer for the initial billing period and the actual usage amount, and wherein the second amount is based at least in part an estimate of the customer's use of the gas service for the second billing period based at least in part on a measure of usage in normal weather which is based at least in part on the customer's past usage and information regarding corresponding Heating Degree Days, wherein the second amount comprises both one or more variable charges and one or more fixed charges, and generate a disconnection notice to be provided with the subsequent bill.

22. The system according to claim 21 wherein the second amount is based at least in part on an updated cost amount corresponding to one or more variable charges.

23. The system according to claim 22 wherein the updated cost amount is based at least in part on an updated fixed cost amount or an updated variable cost amount.

24. The system according to claim 22 wherein the updated cost amount is based at least in part on an updated fixed cost amount and an updated variable cost amount.

25. The system according to claim 13, wherein said software is programmed to enter a new customer account in the database and identify the new customer account as authorized to receive utility service without a requirement for a payment from the customer.

26. The system according to claim 13, wherein the subsequent bill includes a disconnection notice.

27. The system according to claim 13, wherein the software generates the initial amount and the second amount based at least in part on projecting the monthly consumption per demand billing determinant for a preselected time period compiled from at least in part a data set comprising consumption data per demand billing determinant, heating degree days, and the length of the time period.

28. The system according to claim 27, wherein heating degree days data comprises average historical weather data corresponding to the time period.

29. The system according to claim 21, wherein the software generates the initial amount and the second amount based at least in part on projecting the monthly consumption per demand billing determinant for a preselected time period compiled from at least in part a data set comprising consumption data per demand billing determinant, heating degree days, and the length of the time period.

30. The system according to claim 29, wherein heating degree days data comprises average historical weather data for the geographical area corresponding to the time period.

31. The system according to claim 13, wherein said payment is a pre-payment or a customer deposit.

32. The system according to claim 21, wherein said payment is a pre-payment or a customer deposit.

33. A computer system comprising:
a computer processor in communication with the Internet;
a database in communication with said processor for storing customer information corresponding to one or more customers of a gas service;
software that is executable by said processor, wherein said software is programmed to (a) allow said processor to receive and transmit information via the Internet, (b) enter a new customer account in said database without a requirement for a payment corresponding to the account, (c) generate an authorization for the new customer to receive gas service without a requirement for a payment, (d) generate an initial bill for an initial amount to be paid for a utility gas service for an initial billing period, wherein the initial amount is estimated based at least in part on an average consumption rate for the utility gas service in at least one area for a geographic area, wherein the average consumption rate is based on at least in part on a measure indicating the customer's allocation of capacity to serve peak demand for the area and an expected usage amount for normal weather based at least in part on past usage and information regarding corresponding Heating Degree Days, and wherein the initial amount is estimated based on at least in part on one or more fixed charges, (e) generate a subsequent bill for a second amount to be paid for a utility gas service for a second billing period, wherein the second amount is based at least in part on a customer's actual usage of the utility gas service during the first billing period and the difference, if any, between the amount previously paid by the customer for the initial billing period and the actual usage amount, and wherein the second amount is based at least in part an estimate of the customer's use of the gas service for the second billing period for normal weather, wherein the estimate is based at least in part on past information regarding usage and corresponding Heating Degree Days, wherein the second amount comprises both one or more variable charges and one or more fixed charges and generate a disconnection notice to be provided with the subsequent bill, and (f) provide information regarding the status of a customer account over the Internet in response to a request received over the Internet for the information.

34. The computer system according to claim 38 wherein said software is further programmed to (g) receive information via the Internet from a potential new customer for the gas service, (h) receive information regarding the potential new customer's credit, and (i) determine, according to predetermined criteria, whether to accept the potential new customer for the gas service.

35. The computer system according to claim 38 wherein said software is further programmed to (g) generate and send a disconnect notice for a customer account according to predetermined criteria, and (h) update said database with updated information, and wherein said database further comprises information regarding the average consumption rate in the at least one geographic area and a plurality of fixed costs corresponding to the gas service.
